(19) United States
(12) Patent Application Publication
(10) Pub. No.: US 2023/0058752 A1
(43) Pub. Date: Feb. 23, 2023

(54) METHOD FOR CONTROL, BACKUP SYSTEM, AND CONTROL DEVICE

(71) Applicant: BUFFALO INC., Nagoya-shi (JP)

(72) Inventor: Tatsuya ONISHI, Nagoya-shi (JP)

(73) Assignee: BUFFALO INC., Nagoya-shi (JP)

(21) Appl. No.: 17/885,548

(22) Filed: Aug. 11, 2022

(30) Foreign Application Priority Data
Aug. 20, 2021 (JP) 2021-134915

(51) Int. Cl. G06F 11/14

(52) U.S. Cl. CPC G06F 11/1458; G06F 2201/84

(57) ABSTRACT

A method includes storing owner information indicating one or more owners of one or more storage devices and one or more owners of one or more backup storages; and enabling at least one of a backup processing and a restoration processing between a first backup storage of the one or more backup storages and a first storage device of the one or more storage devices, under a condition an owner of the first storage device and an owner of the first backup storage match.

### CROSS-REFERENCE TO RELATED APPLICATIONS

This application is based on and claims priority under 35 USC 119 from Japanese Patent Application No. 2021-134915 filed on Aug. 20, 2021, the contents of which are incorporated herein by reference.

### TECHNICAL FIELD

The present disclosure relates to a method for control, a backup system, and a control device.

### BACKGROUND ART

The related art discloses a backup method of saving data in a cloud storage such as a network attached storage (NAS) that is resistant to a natural disaster. For example, a contract-based cloud backup service is provided. In addition, there is a technique of a service in which a maintenance management company backs up data of a NAS which is a consignment source to a cloud storage.

However, when the maintenance management company manages backup and/or restoration of NASes of a plurality of users (for example, corporate companies), an operation error such as backing up data of a NAS of a user to a cloud storage of another user or restoring backup data of a cloud storage of a user to a NAS of another user may occur.

The contract-based cloud backup service is intended to be used in a company using a NAS or the like, and is not a service for backing up data of a NAS which is a consignment source to a cloud storage.

The present disclosure has been made in view of the above circumstances, and an object of the present disclosure is to improve security of backup and/or restoration.

### SUMMARY

A method includes storing owner information indicating one or more owners of one or more storage devices and one or more owners of one or more backup storages; and enabling at least one of a backup processing and a restoration processing between a first backup storage of the one or more backup storages and a first storage device of the one or more storage devices, under a condition an owner of the first storage device and an owner of the first backup storage match.

A backup system includes: one or more storage devices; one or more backup storages; and a control device configured to control at least one of a backup processing and a restoration processing of data between the one or more storage devices and the one or more backup storages via a network, store owner information indicating one or more owners of the one or more storage devices and one or more owners of the one or more backup storages, and enable at least one of the backup processing and the restoration processing between a first backup storage of the one or more backup storages and a first storage device of the one or more storage devices under a condition the owner of the first storage device and the owner of the first backup storage match each other.

A control device comprising circuitry configured to store owner information indicating one or more owners of one or more storage devices and one or more owners of one or more backup storages, and enable at least one of a backup processing and a restoration processing of data between a first backup storage of the one or more backup storage and a first storage device of the one or more storage devices under a condition the owner of the first storage device and the owner of the first backup storage match each other.

### BRIEF DESCRIPTION OF DRAWINGS

Exemplary embodiments of the present invention will be described in detail based on the following figures, wherein:

FIG. 1 is a diagram showing an example of a backup system 1 according to an embodiment of the present disclosure;

FIG. 2 is a diagram showing an example of a hardware configuration of a control device 30;

FIG. 3 is a diagram showing an example of a hardware configuration of a maintenance management terminal 40;

FIG. 4 is a sequence diagram showing an example of a backup operation in the backup system 1;

FIG. 5 is a diagram showing an example of screen transition of the maintenance management terminal 40 in the backup operation shown in FIG. 4;

FIG. 6 is a sequence diagram showing an example of a restoration operation in the backup system 1;

FIG. 7 is a sequence diagram showing another example of a backup operation in the backup system 1;

FIG. 8 is a diagram showing an example of screen transition of the maintenance management terminal 40 in the backup operation shown in FIG. 7;

FIG. 9 is a diagram showing another example of the backup system 1; and

FIG. 10 is a sequence diagram showing an example of a backup operation in the backup system 1 according to an operation from a corporate company A.

### DESCRIPTION OF EMBODIMENTS

Hereinafter, embodiments of the present disclosure will be described with reference to the drawings.

<Backup System 1 According to an Embodiment of Present Disclosure>

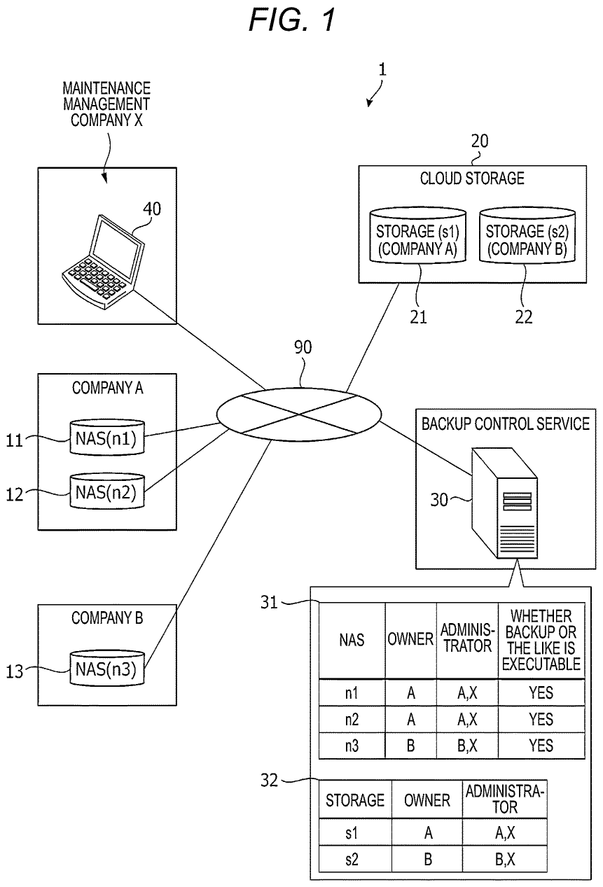

FIG. 1 is a diagram showing an example of a backup system 1 according to an embodiment of the present disclosure. The backup system 1 shown in FIG. 1 includes, for example, NASes 11 to 13, a cloud storage 20, a control device 30, and a maintenance management terminal 40. These components are connected to one another via a network 90. The network 90 is a wide area network (WAN) such as the Internet.

The NASes 11 to 13 have a communication function and are storage devices connected to the network 90. IDs of the NASes 11 to 13 are n1 to n3, respectively. The NASes 11 and 12 are NASes used by a corporate company A in the company. The NAS 13 is a NAS used by a corporate company B in a company different from the corporate company A.

In this case, the corporate company A is an owner of the NASes 11 and 12, and the corporate company B is an owner of the NAS 13. An owner (e.g., a first owner) of a NAS is a person (e.g., a user) who has a right to store data in the NAS. Therefore, an owner of a NAS is not limited to a person (for example, a purchaser) who has the ownership of the NAS in the present embodiment, and includes a person who uses the NAS by rental or lease from another person. For example, the NASes 11 and 12 may be purchased and used by the corporate company A, or may be used by rental or lease from another person (for example, a maintenance management company X).

The cloud storage 20 is a storage system capable of storing and reading data via the network 90, and includes storages 21 and 22. The storages 21 and 22 are backup storages used for backing up and/or restoring data. The storage 21 is a storage area (e.g., storage capacity) which is allocated to the corporate company A in the cloud storage 20 and in which the corporate company A can store data of the corporate company A. The storage 22 is a storage area (e.g., storage capacity) which is allocated to the corporate company B in the cloud storage 20 and in which the corporate company B can store data of the corporate company B.

In this case, the corporate company A is an owner of the storage 21, and the corporate company B is an owner of the storage 22. An owner (e.g., a second owner) of a storage is a person (e.g., a user) to whom a storage area (e.g., storage capacity) of the storage is allocated and who has a right to store data in the storage. Therefore, an owner of a storage is not limited to a person to whom a storage area of the storage is allocated by a contract with an operator of the cloud storage 20, and includes a person to whom the storage area is further allocated by the above-described person. For example, the storage 21 may be a storage allocated to the corporate company A by making a contract between the corporate company A and an operator of the cloud storage 20, or may be a storage that is allocated to another person (for example, the maintenance management company X) by making a contract between the other person and the operator of the cloud storage 20 and that is allocated to the corporate company A by the other person.

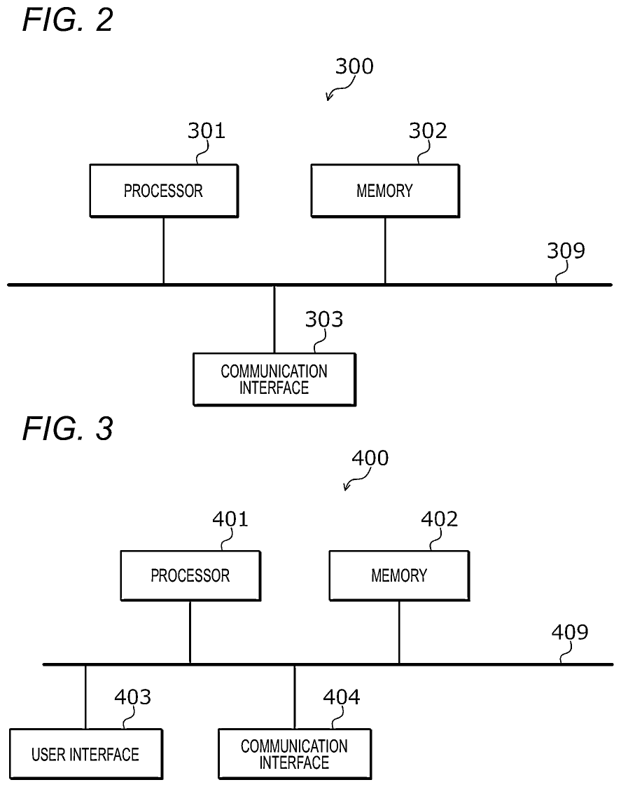

The control device 30 provides a backup control service that controls at least one of a backup processing and a restoration processing of data between the NASes 11 to 13 and the storages 21 and 22 via the network 90. The control device 30 may be a virtual information processing device implemented in a cloud computing service, or may be a physical information processing device (for example, see FIG. 2) implemented as a single device.

For example, the control device 30 controls the NAS 11 and the cloud storage 20 to transmit data stored in the NAS 11 to the cloud storage 20 via the network 90. The control device 30 stores the data as backup data in the storage 21 of the cloud storage 20, thereby backing up the data of the NAS 11.

After the backup processing, for example, when the data in the NAS 11 is damaged, the control device 30 controls the NAS 11 and the cloud storage 20 to transmit the data stored as the backup data in the storage 21 from the cloud storage 20 to the NAS 11 via the network 90. In addition, the control device 30 restores the data of the NAS 11 by storing the data in the NAS 11.

The control device 30 stores NAS management information 31 and storage management information 32. For example, the control device 30 stores the NAS management information 31 and the storage management information 32 in a memory (for example, a memory 302 shown in FIG. 2) of the control device 30. Alternatively, the control device 30 may be able to communicate with an external device that stores the NAS management information 31 and the storage management information 32 via, for example, a communication interface 303 shown in FIG. 2.

The NAS management information 31 is information indicating an owner of each NAS to be managed by the control device 30. The NAS to be managed by the control device 30 is a NAS that can be accessed by the control device 30 in order to control the backup processing and/or the restoration processing described above, and includes the NASes 11 to 13 (n1 to n3) in the example of FIG. 1. For example, the NAS management information 31 indicates that an owner of the NASes 11 and 12 (n1, n2) is the corporate company A and an owner of the NAS 13 (n3) is the corporate company B.

The NAS management information 31 includes information indicating an administrator (e.g., a first administrator) of each NAS to be managed by the control device 30. The administrator of the NAS is a person who has an instruction right to instruct a backup processing and/or a restoration processing using the NAS as a backup source. For example, the NAS owned by the corporate company A includes the following types (a) and (b).

(a) The corporate company A uses the NAS by purchasing or rental, and only the corporation A has an instruction right of the NAS.

(b) The corporate company A uses the NAS by purchasing or rental, and the corporate company A and the maintenance management company X are administrators of the NAS.

In the example of FIG. 1, the NAS management information 31 indicates that an administrator of the NASes 11 and 12 (n1, n2) is the corporate company A and the maintenance management company X (A and X), and the administrator of the NAS 13 (n3) is the corporate company B and the maintenance management company X (B and X).

Furthermore, the NAS management information 31 may include information indicating whether the backup processing described above can be executed by the control device 30 in each NAS to be managed by the control device 30. For example, an owner of a NAS or a maintenance administrator (e.g., the maintenance management company X) of a NAS set whether the backup processing can be executed by the control device 30. In the example of FIG. 1, the NAS management information 31 indicates whether an operation can be executed by the control device 30 in the NASes 11 to 13.

The storage management information 32 is information indicating an owner of each storage to be managed by the control device 30. The storage to be managed by the control device 30 is a storage that can be accessed by the control device 30 in order to control the backup processing and/or the restoration processing described above, and includes the storages 21 and 22 (s1 and s2) in the example of FIG. 1. For example, the storage management information 32 indicates that an owner of the storage 21 (s1) is the corporate company A and an owner of the storage 22 (s2) is the corporate company B.

The storage management information 32 includes information indicating an administrator (e.g., a second administrator) of each storage to be managed by the control device 30. The administrator of the storage is a person who has an instruction right to instruct a backup processing and/or a restoration processing using the storage as a backup destination. For example, a storage owned by the corporate company A includes the following types (1) to (4).

(1) A storage is allocated to the corporate company A by making a contract between the corporate company A and an operator of the cloud storage 20, and only the corporate company A has an instruction right.

(2) A storage is allocated to the corporate company A by making a contract between the corporate company A and an operator of the cloud storage 20, and the corporate company A and the maintenance management company X are administrators of the storage.

(3) A storage is allocated to the maintenance management company X by making a contract between the maintenance management company X and an operator of the cloud storage 20, the maintenance management company X further allocates the storage to the corporate company A, and only the maintenance management company X has an instruction right.

(4) A storage is allocated to the maintenance management company X by making a contract between the maintenance management company X and an operator of the cloud storage 20, the maintenance management company X further allocates the storage to the corporate company A, and the corporate company A and the maintenance management company X are administrators of the storage.

In the example of FIG. 1, the storage management information 32 indicates that administrators of the storage 21 (s1) are the corporate company A and the maintenance management company X, and administrators of the storage 22 (s3) are the corporate company B and the maintenance management company X.

The NAS management information 31 and the storage management information 32 are examples of owner information indicating a first owner of a storage device (NAS) and a second owner of a backup storage, and administrator information indicating a first administrator of the storage device and a second administrator of the backup storage. Alternatively, the owner information and the administrator information are not limited to the information in the format as shown in FIG. 1, and may be information in other formats.

For example, the owner information and the administrator information may be information indicating what attributes each company has for a device of a NAS or a storage (e.g., whether a company has a device, whether companies share a device, whether a company is an end user of a device, whether a company is a maintenance administrator of a device, or the like). The control device 30 may determine an owner or an administrator of each NAS or each storage according to a predetermined procedure based on such information.

The maintenance management terminal 40 is an information terminal used by the maintenance management company X in the company. The maintenance management company X performs maintenance management of the NASes 11 and 12 used by the corporate company A and the NAS 13 used by the corporate company B according to a contract between the maintenance management company X and the corporate companies A and B. The maintenance management of a NAS includes the execution of the backup processing and/or the restoration processing described above using the control device 30.

For example, an operator of the maintenance management terminal 40 (e.g., an employee of the maintenance management company X) operates the maintenance management terminal 40 to instruct the control device 30 about a NAS which is a backup source, a storage which is a backup destination, and a processing to be executed of a backup processing and a restoration processing, thereby causing the control device 30 to execute a backup and/or restoration control.

<Hardware Configuration of Control Device 30>

FIG. 2 is a diagram showing an example of a hardware configuration of the control device 30, shown in FIG. 1. A case where the control device 30 shown in FIG. 1 is implemented by a physical information processing device 300 will be described. The information processing device 300 includes a processor 301, a memory 302, and a communication interface 303. The processor 301, the memory 302, and the communication interface 303 are connected by, for example, a bus 309.

The processor 301 is a circuit that executes a signal processing, and is, for example, a central processing unit (CPU) that controls the entire control device 30. The processor 301 may be implemented by another digital circuit such as a field programmable gate array (FPGA) or a digital signal processor (DSP). The processor 301 may be implemented by combining a plurality of digital circuits.

The memory 302 includes, for example, a main memory and an auxiliary memory. The main memory is, for example, a random access memory (RAM). The main memory is used as a work area of the processor 301.

The auxiliary memory is, for example, a nonvolatile memory such as a magnetic disk, an optical disk, or a flash memory. Various programs for operating the control device 30 are stored in the auxiliary memory. The program stored in the auxiliary memory is loaded into the main memory and executed by the processor 301.

The auxiliary memory may include a portable memory that is removable from the control device 30. Examples of the portable memory include a memory card such as a universal serial bus (USB) flash drive or a secure digital (SD) memory card, and an external hard disk drive. The NAS management information 31 and the storage management information 32 shown in FIG. 1 are stored in, for example, the auxiliary memory of the memory 302.

The communication interface 303 is a communication interface that communicates with the outside of the control device 30 (for example, the NASes 11 to 13, the cloud storage 20, and the maintenance management terminal 40). The communication interface 303 is controlled by the processor 301.

Alternatively, the control device 30 is not limited to the physical information processing device 300 as shown in FIG. 2, and may be a virtual information processing device implemented in a cloud computing service. In this case, the control device 30 executes various processing by using resources allocated to the control device 30 among resources such as a processor, a memory, and a communication Internet of the cloud computing service.

<Hardware Configuration of Maintenance Management Terminal 40>

FIG. 3 is a diagram showing an example of a hardware configuration of the maintenance management terminal 40, shown in FIG. 1. The maintenance management terminal 40 shown in FIG. 1 may be implemented by, for example, an information processing device 400 shown in FIG. 3. The information processing device 400 includes a processor 401, a memory 402, a user interface 403, and a communication interface 404. The processor 401, the memory 402, the user interface 403, and the communication interface 404 are connected by, for example, a bus 409.

The processor 401 is a circuit that executes a signal processing, and is, for example, a CPU that controls the entire information processing device 400. The processor 401 may be implemented by another digital circuit such as an FPGA or a DSP. The processor 401 may be implemented by combining a plurality of digital circuits.

The memory 402 includes, for example, a main memory and an auxiliary memory. The main memory is, for example, a RAM. The main memory is used as a work area of the processor 401. The auxiliary memory is, for example, a nonvolatile memory such as a magnetic disk, an optical disk, or a flash memory. Various programs for operating the information processing device 400 are stored in the auxiliary memory. The program stored in the auxiliary memory is loaded into the main memory and executed by the processor 401. The auxiliary memory may include a portable memory that is removable from the information processing device 400. Examples of the portable memory include a memory card such as a

USB flash drive or an SD memory card, and an external hard disk drive.

The user interface 403 includes, for example, an input device that receives an input operation from a user, an output device that outputs information to the user, and the like. The input device can be implemented by, for example, a pointing device (for example, a mouse), keys (for example, a keyboard), a remote controller, or the like. The output device can be implemented by, for example, a display, a speaker, or the like. In addition, the input device and the output device may be implemented by a touch panel or the like. The user interface 403 is controlled by the processor 401.

The communication interface 404 is a communication interface that communicates with the outside of the information processing device 400 (for example, the control device 30).

The communication interface 404 is controlled by the processor 401.

<Backup Operation in Backup System 1>

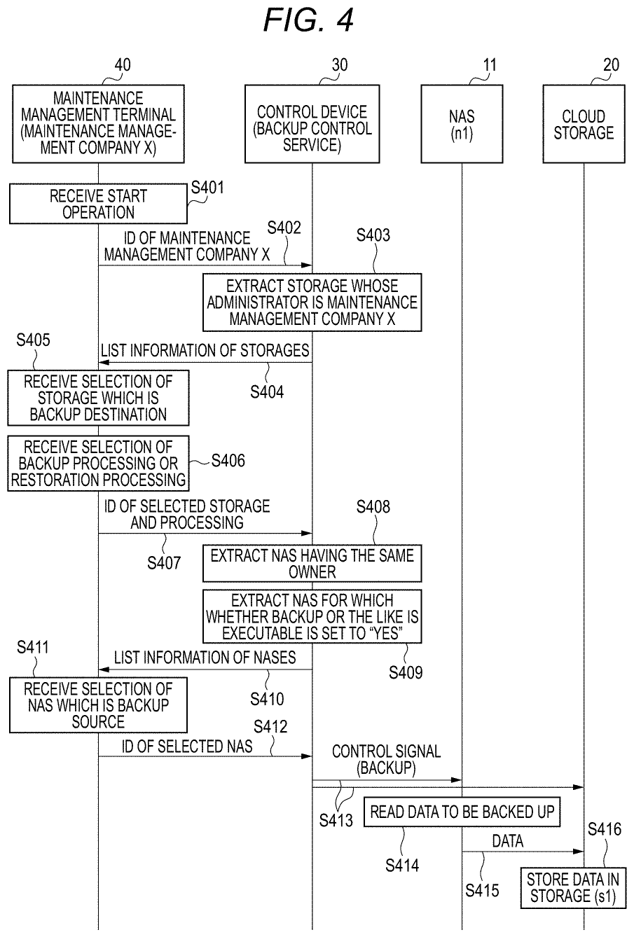

FIG. 4 is a sequence diagram showing an example of a backup operation in the backup system 1. In the backup system 1 shown in FIG. 1, for example, an operation shown in FIG. 4 is executed as the backup operation.

First, the maintenance management terminal 40 of the maintenance management company X receives a start operation of a processing related to backup (step S401). For example, the maintenance management terminal 40 receives a start operation from an operator of the maintenance management terminal 40 through the user interface 403 shown in FIG. 3.

Next, the maintenance management terminal 40 transmits identification information (ID) of the maintenance management company X to the control device 30 (step S402). The ID of the maintenance management company X is stored in advance in the memory 402 of the maintenance management terminal 40.

Next, the control device 30 extracts a storage whose administrator is the maintenance management company X from storages to be managed by the control device 30 based on the ID of the maintenance management company X transmitted in the step S402 and the storage management information 32 (step S403). The storage to be managed by the control device 30 is a storage included in the storage management information 32. The storage whose administrator is the maintenance management company X is a storage whose administrator includes the maintenance management company X in the storage management information 32.

Next, the control device 30 transmits list information of storages extracted in the step S403 to the maintenance management terminal 40 (step S404). Next, the maintenance management terminal 40 receives selection of a storage which is a backup destination from the storages indicated by the list information transmitted in the step S404 (step S405).

The maintenance management terminal 40 receives selection of a processing to be executed from a backup processing and a restoration processing (step S406). In the steps S404 and S405, the maintenance management terminal 40 uses the user interface 403 shown in FIG. 3 to display options to an operator of the maintenance management terminal 40 and receive a selection operation from the operator of the maintenance management terminal 40.

Next, the maintenance management terminal 40 transmits the ID of the storage selected in the step S405 and information indicating the processing selected in the step S406 of the backup processing and the restoration processing to the control device 30 (step S407).

Next, the control device 30 extracts a NAS having the same owner as the storage indicated by the ID transmitted in the step S407 from the NASes whose administrator is the maintenance management company X, based on the NAS management information 31 and the storage management information 32 (step S408). The NAS whose administrator is the maintenance management company X is a NAS whose administrator includes the maintenance management company X in the NAS management information 31.

Next, based on the NAS management information 31, the control device 30 extracts a NAS for which “whether backup or the like is executable” is set to “YES” from NASes extracted in the step S408 (step S409). Next, the control device 30 transmits list information of NASes extracted in the step S409 to the maintenance management terminal 40 (step S410).

Next, the maintenance management terminal 40 receives selection of a NAS which is a backup source from NASes indicated by the list information transmitted in the step S410 (step S411). For example, the maintenance management terminal 40 uses the user interface 403 shown in FIG. 3 to display options to an operator of the maintenance management terminal 40 and receive a selection operation from the operator of the maintenance management terminal 40. Next, the maintenance management terminal 40 transmits the ID of the NAS selected in the step S411 to the control device 30 (step S412).

Next, the control device 30 transmits a control signal for instructing to back up or restore data, based on the information received from the maintenance management terminal 40 in the steps S407 and S412 (step S413). Specifically, the control device 30 transmits a control signal for setting the storage indicated by the ID transmitted in the step S407 as a backup destination, setting the NAS indicated by the ID transmitted in the step S412 as a backup source, and executing a processing indicated by the information transmitted in the step S407, such as a backup processing or a restoration processing.

In the example of FIG. 4, the storage 21 is selected as the backup destination in the step S405, the backup processing is selected as the processing in the step S406, and the NAS 11 (n1) is selected as the backup source in the step S411. In this case, the control device 30 transmits, to the NAS 11 and the cloud storage 20, a control signal for setting the storage 21 as the backup destination, setting the NAS 11 as the backup source, and instructing to execute the backup processing.

Next, the NAS 11 reads data to be backed up from data stored in a storage medium of the NAS 11 (step S414). The data to be backed up may be all the data stored in the storage medium of the NAS 11, or may be data set by a user of the NAS 11 among the data stored in the storage medium of the NAS 11.

Next, the NAS 11 transmits the data read in the step S414 to the cloud storage 20 (step S415). Next, the cloud storage 20 stores the data transmitted in the step S415 in the storage 21 (s1) owned by the corporate company A (step S416). As a result, the storage medium of the NAS 11 is backed up in the storage 21.

Although an example in which the step S406 of receiving the selection of a processing to be executed of the backup processing and the restoration processing is executed immediately after the step S405 of receiving the selection of the backup destination has been described in FIG. 4, the execution timing of the processing of receiving the selection of the processing to be executed of the backup processing and the restoration processing is not limited thereto. For example, the execution timing of the step S406 of receiving the selection of the processing to be executed of the backup processing and the restoration processing may be immediately before the step S405, immediately after the step S401, or immediately before or immediately after the step S411.

<Screen Transition of Maintenance Management Terminal 40 in Backup Operation

Shown in FIG. 4>

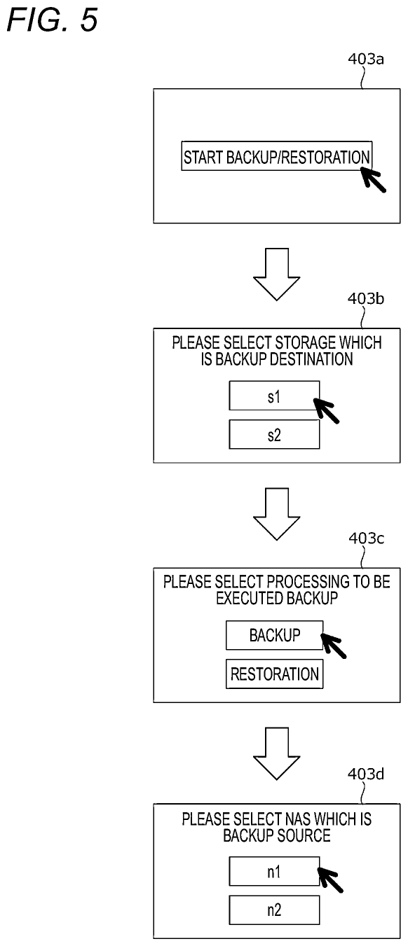

FIG. 5 is a diagram showing an example of screen transition of the maintenance management terminal 40 shown in FIG. 1 during the backup operation shown in FIG. 4.

In the step S401 shown in FIG. 4, the maintenance management terminal 40 displays an operation screen 403a using, for example, the user interface 403. The operation screen 403a includes a “backup/restoration start” button for starting a backup processing or a restoration processing, and the maintenance management terminal 40 receives an instruction operation (a click operation or a touch operation) of the “backup/restoration start” button as the start operation in the step S401.

In the step S405 shown in FIG. 4, the maintenance management terminal 40 displays an operation screen 403b using, for example, the user interface 403. The operation screen 403b includes a message for prompting a user to select a storage which is a backup destination and a button for selecting the storage which is the backup destination. For example, since a storage whose administrator is the maintenance management company X includes the storages 21 and 22 (s1 and s2) in the example shown in FIG. 1, the operation screen 403b includes an “s1” button for selecting the storage 21 and an “s2” button for selecting the storage 22. In the present example, the “s1” button for selecting the storage 21 is designated.

In the step S406 shown in FIG. 4, the maintenance management terminal 40 displays an operation screen 403c using, for example, the user interface 403. The operation screen 403c includes a message for prompting the selection of a processing to be executed, a “backup” button for selecting a backup processing, and a “restoration” button for selecting a restoration processing. In the present example, the “backup” button for selecting a backup processing is designated.

In the step S411 shown in FIG. 4, the maintenance management terminal 40 displays an operation screen 403d using, for example, the user interface 403. The operation screen 403d includes a message for prompting a user to select a NAS which is a backup source and a button for selecting the NAS which is a backup source. For example, since a NAS whose owner is the same as the owner of the storage 21 selected on the operation screen 403b and whose administrator is the maintenance management company X includes the NASes 11 and 12 (n1 and n2) in the example shown in FIG. 1, the operation screen 403d includes an “n1” button for selecting the NAS 11 and an “n2” button for selecting the NAS 12. In the present example, the “n1” button for selecting the NAS 11 is designated.

As a result, the backup processing is executed in which the storage 21 is set as the backup destination and the NAS 11 is set as the backup source as shown in FIG. 4. Thereafter, a result of the backup processing may be transmitted to the maintenance management terminal 40, and the maintenance management terminal 40 may display a message indicating that the backup processing is executed.

In this manner, the NAS 11 and the NAS 12 whose owner (the corporate company A) is the same as the owner of the storage 21 selected by an operator (the maintenance management company X) are presented as options of the backup source, and the NAS 13 whose owner is different from the owner of the storage 21 is not presented as an option of the backup source even when the operator is an administrator, so that it is possible to prevent an operation error of instructing to back up the data of the NAS 13 of the corporate company B to the storage 21 of the corporate company A.

<Restoration Operation in Backup System 1>

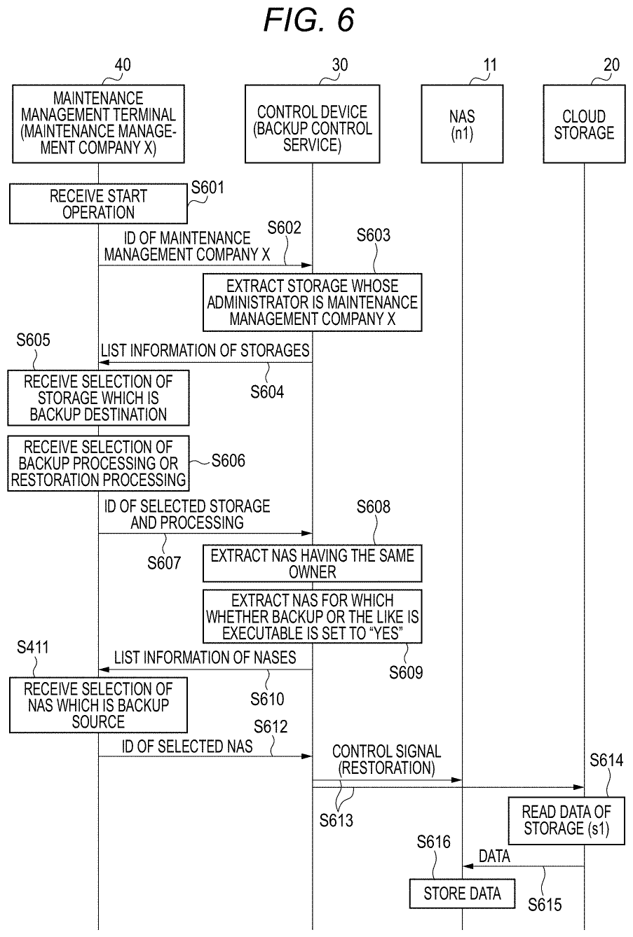

FIG. 6 is a sequence diagram showing an example of a restoration operation in the backup system 1. In the backup system 1, for example, an operation shown in FIG. 6 is executed as the restoration operation. In the present example, for example, backup data of the NAS 11 is stored in the storage 21 by the backup operation shown in FIG. 4.

Steps S601 to S612 shown in FIG. 6 are the same as steps S401 to S412 shown in FIG. 4. In the example of FIG. 6, the storage 21 is selected as a backup destination in the step S605, a restoration processing is selected as a processing in the step S606, and the NAS 11 is selected as a backup source in the step S611. In this case, after the step S612, the control device 30 transmits, to the NAS 11 and the cloud storage 20, a control signal for instructing a restoration processing in which the storage 21 is set as the backup destination and the NAS 11 is set as the backup source (step S613).

Next, the cloud storage 20 reads data of the storage 21 stored as backup data of the NAS 11 (step S614). Next, the cloud storage 20 transmits the data read in the step S614 to the NAS 11 (step S615). Next, the NAS 11 stores the data transmitted in the step S615 in a storage medium of the NAS 11 (step S616). As a result, the data of the NAS 11 backed up to the storage 21 of the cloud storage 20 is restored to the NAS 11.

Screen transition of the maintenance management terminal 40 in the restoration operation shown in FIG. 6 is the same as the screen transition of the maintenance management terminal 40 shown in FIG. 5. In the step S606, a “restore” button for selecting a restoration processing is designated on the operation screen 403c.

In this manner, the NAS 11 and the NAS 12 whose owner (the corporate company A) is the same as the owner of the storage 21 selected by an operator (the maintenance management company X) are presented as options of the backup source, and the NAS 13 whose owner is different from the owner of the storage 21 is not presented as an option of the backup source even when the operator is an administrator, so that it is possible to prevent an operation error of instructing to restore the backup data of the storage 21 of the corporate company A to the NAS 13 of the corporate company B.

<Another Example of Backup Operation in Backup System 1>

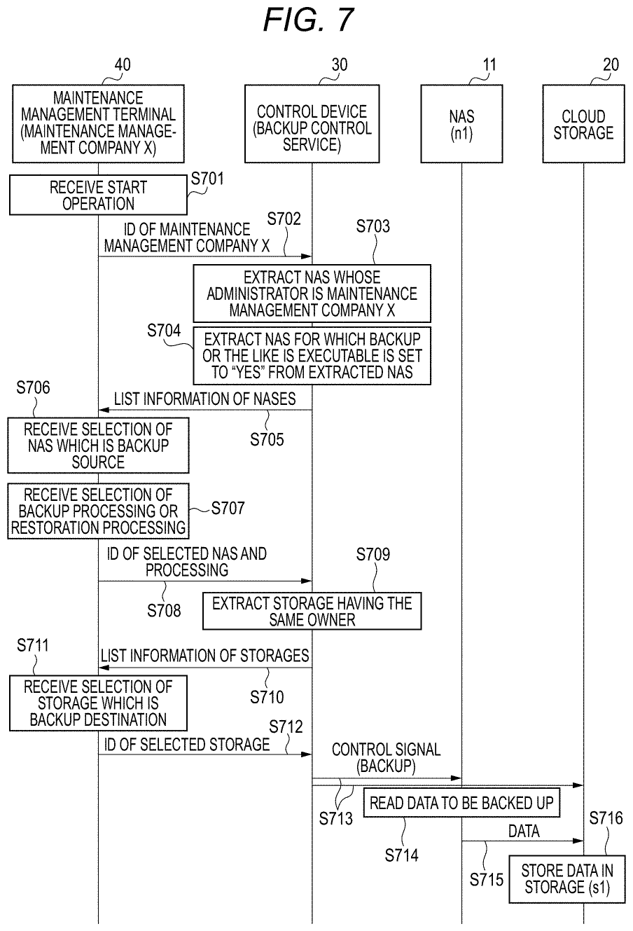

FIG. 7 is a sequence diagram showing another example of a backup operation in the backup system 1. In the backup system 1, for example, an operation shown in FIG. 7 may be executed as the backup operation.

Steps S701 and S702 shown in FIG. 7 are the same as steps S401 and S402 shown in FIG. 4. After the step S702, the control device 30 extracts a NAS whose administrator is the maintenance management company X from NASes to be managed by the control device 30 based on the ID of the maintenance management company X transmitted in the step S702 and the NAS management information 31 (step S703). The NAS to be managed by the control device 30 is a NAS included in the NAS management information 31. The NAS whose administrator is the maintenance management company X is a NAS whose administrator includes the maintenance management company X in the NAS management information 31.

Next, based on the NAS management information 31, the control device 30 extracts a NAS for which “whether backup or the like is executable” is set to “YES” from NASes extracted in the step S703 (step S704). Next, the control device 30 transmits list information of NASes extracted in the step S704 to the maintenance management terminal 40 (step S705).

Next, the maintenance management terminal 40 receives selection of a NAS which is a backup source from NASes indicated by the list information transmitted in the step S705 (step S706). The maintenance management terminal 40 receives selection of a processing to be executed from a backup processing and a restoration processing (step S707).

Next, the maintenance management terminal 40 transmits the ID of the NAS selected in the step S706 and information indicating the processing selected in the step S707 of the backup processing and the restoration processing to the control device 30 (step S708).

Next, the control device 30 extracts a storage having the same owner as the owner of the NAS indicated by the ID transmitted in the step S708 from the storages to be managed by the control device 30 (step S709). Next, the control device 30 transmits list information of storages extracted in the step S709 to the maintenance management terminal 40 (step S710).

Next, the maintenance management terminal 40 receives selection of a storage which is a backup destination from the storages indicated by the list information transmitted in the step S710 (step S711). Next, the maintenance management terminal 40 transmits the ID of the storage selected in the step S711 to the control device 30 (step S712).

Steps S713 to S716 are the same as steps S413 to S416 shown in FIG. 4, respectively. In the step S713, the control device 30 transmits a control signal for setting the NAS indicated by the ID transmitted in the step S708 as a backup source, setting the storage indicated by the ID transmitted in the step S712 as a backup destination, and executing a processing indicated by the information transmitted in the step S708, such as a backup processing and a restoration processing.

As shown in FIG. 7, when data backup is performed, the selection of a NAS which is a backup source may be received first, and the selection of a storage which is a backup destination may be received next. Although not shown in the drawing, when the data is restored as shown in FIG. 6, the selection of the NAS which is a backup source may be received first, and the selection of the storage which is a backup destination may be received next.

<Screen Transition of Maintenance Management Terminal 40 in Backup Operation Shown in FIG. 7>

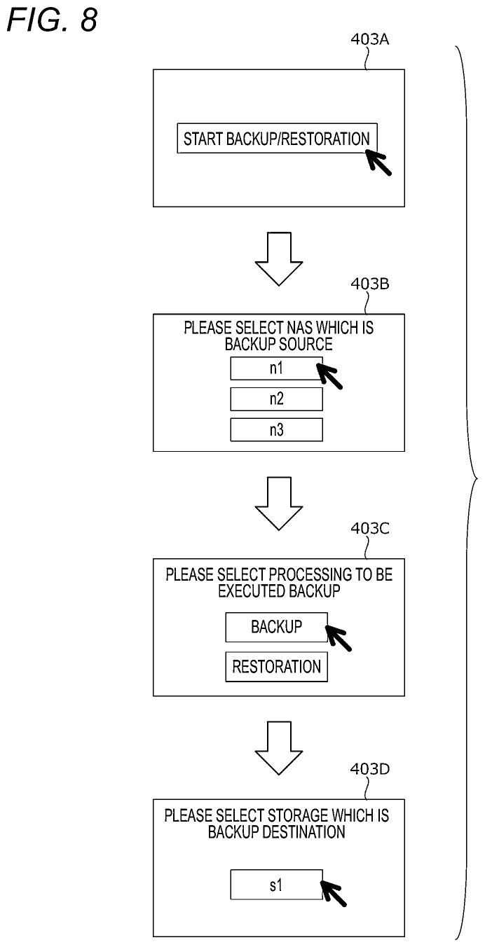

FIG. 8 is a diagram showing an example of screen transition of the maintenance management terminal 40 in the backup operation shown in FIG. 7.

In the step S701 shown in FIG. 7, the maintenance management terminal 40 displays an operation screen 403A using, for example, the user interface 403. The operation screen 403A is the same as the operation screen 403a shown in FIG. 5.

In the step S706 shown in FIG. 7, the maintenance management terminal 40 displays an operation screen 403B using, for example, the user interface 403. The operation screen 403B includes a message for prompting a user to select a NAS which is a backup source and a button for selecting the NAS which is a backup source. For example, in the example shown in FIG. 1, since the NAS whose administrator is the maintenance management company X includes the NASes 11 to 13 (n1 to n3), the operation screen 403B includes an “n1” button for selecting the NAS 11, an “n2” button for selecting the NAS 12, and an “n3” button for selecting the NAS 13. In the present example, the “n1” button for selecting the NAS 11 is designated.

In the step S707 shown in FIG. 7, the maintenance management terminal 40 displays an operation screen 403C using, for example, the user interface 403. The operation screen 403C is the same as the operation screen 403c shown in FIG. 5.

In the step S711 shown in FIG. 7, the maintenance management terminal 40 displays an operation screen 403D using, for example, the user interface 403. The operation screen 403D includes a message for prompting a user to select a storage which is a backup destination and a button for selecting the storage which is a backup destination. For example, in the example shown in FIG. 1, since a storage whose owner is the same as the owner of the NAS 11 selected on the operation screen 403B and whose administrator is the maintenance management company X is the storage 21 (s1), the operation screen 403D includes an “s1” button for selecting the storage 21. In the present example, the “s1” button for selecting the storage 21 is designated.

As a result, the backup processing is executed in which the storage 21 is set as a backup destination and the NAS 11 is set as a backup source, as shown in FIG. 7. Thereafter, a result of the backup processing may be transmitted to the maintenance management terminal 40, and the maintenance management terminal 40 may display a message indicating that the backup processing is executed.

As described above, the storage 21 whose owner (e.g., the corporate company A) is the same as the owner of the NAS 11 selected by an operator (e.g., the maintenance management company X) is presented as an option of a backup destination, and the storage 22 whose owner is different from the owner of the NAS 11 is not presented as an option of a backup destination even when the operator is the administrator, so that it is possible to prevent an operation error of instructing to back up the data of the NAS 11 of the corporate company A to the storage 22 of the corporate company B.

<Another Example of Backup System 1>

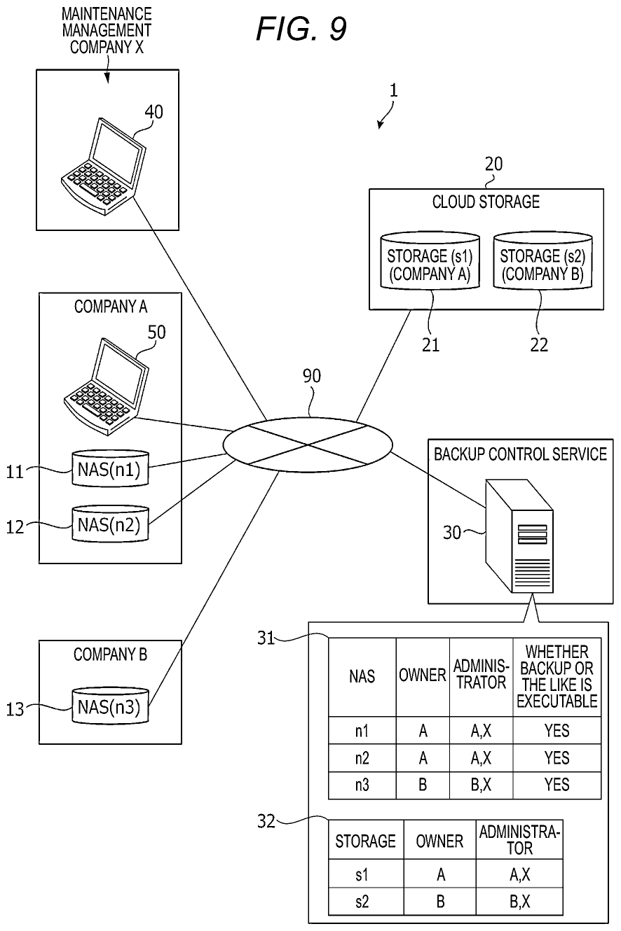

FIG. 9 is a diagram showing another example of the backup system 1. The backup system 1 may include a maintenance management terminal 50 in addition to the maintenance management terminal 40, or may include the maintenance management terminal 50 instead of the maintenance management terminal 40. The maintenance management terminal 50 is connected to the network 90 in the same manner as other components of the backup system 1.

The maintenance management terminal 50 is an information terminal used by the corporate company A in the company, and performs maintenance management of the NASes 11 and 12 used by the corporate company A. For example, an operator of the maintenance management terminal 50 (an employee of the corporate company A) operates the maintenance management terminal 50 to instruct the control device 30 about a NAS which is a backup source, a storage which is a backup destination, and a processing to be executed of a backup processing and a restoration processing, thereby causing the control device 30 to execute a backup and/or restoration control.

<Backup Operation in Backup System 1 according to Operation from Corporate Company A>

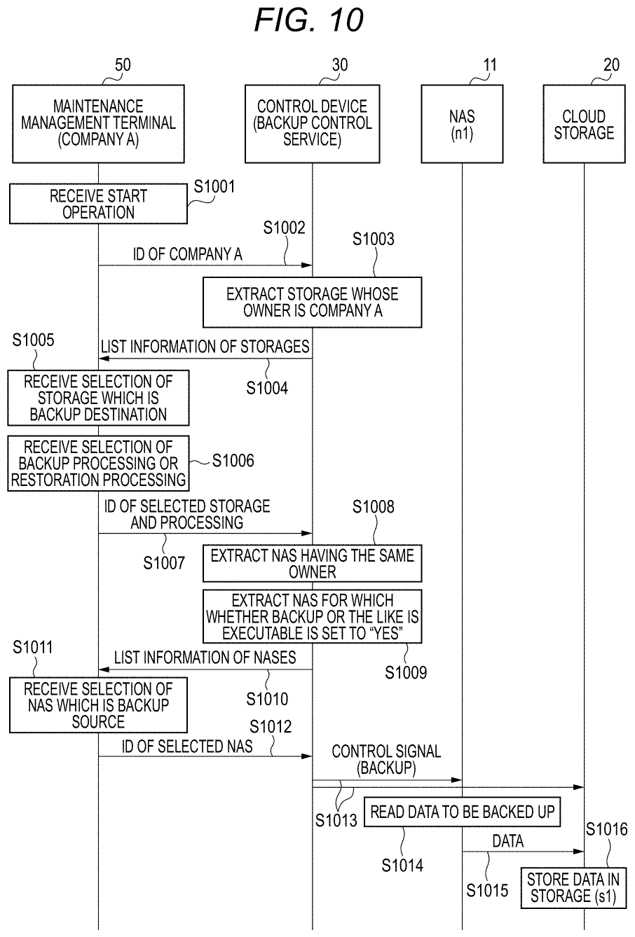

FIG. 10 is a sequence diagram showing an example of a backup operation in the backup system 1 according to an operation from the corporate company A. In the backup system 1 shown in FIG. 9, for example, an operation shown in FIG. 10 is executed as the backup operation.

Steps S1001 to S1016 shown in FIG. 10 are the same as steps S401 to S416 shown in FIG. 4 except that the maintenance management terminal 40 is replaced by the maintenance management terminal 50 as a subject of the processing. In the step S1002, the maintenance management terminal 50 transmits identification information (ID) of the corporate company A to the control device 30 (step S1002).

In the step S1003, the control device 30 extracts a storage whose administrator is the corporate company A from storages to be managed by the control device 30 based on the ID of the maintenance management company X transmitted in the step S1002 and the storage management information 32 (step S1003).

In the step S1008, the control device 30 extracts a NAS having the same owner as the storage indicated by the ID transmitted in the step S1007 from NASes whose administrator is the corporate company A, based on the NAS management information 31 and the storage management information 32 (step S1008).

Screen transition of the maintenance management terminal 50 in the backup operation shown in FIG. 10 is the same as the screen transition of the maintenance management terminal 40 shown in FIG. 5.

In the configuration shown in FIG. 9, a restoration operation may be performed as shown in FIG. 6 based on an instruction from the maintenance management terminal 50, or the selection of a NAS which is a backup source may be received first and the selection of a storage which is a backup destination may be received next as shown in FIG. 7.

As described with reference to FIGS. 9 and 10, a backup or restoration instruction to the control device 30 may be issued not only from the maintenance management terminal 40 of the maintenance management company X but also from the maintenance management terminal 50 of the corporate company A who is an owner of a NAS to be backed up.

As described above, the control device 30 stores owner information (the NAS management information 31 and the storage management information 32) indicating a first owner of a storage device (the NASes 11 to 13) and a second owner of a backup storage (the storages 21 and 22) and controls whether at least one of a backup processing and a restoration processing is executable between the backup storage and the storage device via the network 90 when the first owner and the second owner match each other.

As a result, it is possible to prevent data from being backed up and/or restored between a storage device and a backup storage when owners do not match due to an operation error of an operator, and it is possible to improve the security of backup and/or restoration.

For example, as shown in FIGS. 4 to 6, the control device 30 controls to transmit list information of selectable storages to the maintenance management terminal 40 (or the maintenance management terminal 50) to enable an operator (for example, an operator of the maintenance management terminal 40) to select a backup storage, extract a storage device having a first owner that matches a second owner of the selected backup storage, and enable the operator to select a storage device based on the extraction result. Specifically, the control device 30 controls to prevent the operator from selecting a storage device that is not extracted.

For example, as a control for preventing the operator from selecting a storage device that is not extracted, the control device 30 transmits list information of only extracted storage devices to the maintenance management terminal 40, thereby presenting only the extracted storage devices as options to the operator on the maintenance management terminal 40.

The control for preventing the operator from selecting a storage device that is not extracted is not limited thereto. For example, the control device 30 may control to present storage devices including a storage device that is not extracted to an operator from the maintenance management terminal 40, and present the storage device that is not extracted in a form different from a form of an extracted storage device, such as making the display image of the storage device that is not extracted (e.g., icon) lighter, or displaying the storage device that is not extracted with a display image (e.g., icon) indicating that the storage device is not selectable.

Alternatively, the control device 30 may control to present the maintenance management terminal 40 including the storage device that is not extracted to an operator and the storage device that is not extracted cannot be selected even when the operator performs a selection operation. Alternatively, the control device 30 may control to present the maintenance management terminal 40 including the storage device that is not extracted to an operator, and when the storage device that is not extracted is selected, the maintenance management terminal 40 displays warning information including a message indicating that owners do not match or the like for the operator, and further receives a cancelling operation for cancelling the selection operation from the operator.

As shown in FIGS. 7 and 8, the control device 30 may control to transmit list information of selectable storage devices to the maintenance management terminal 40 (or the maintenance management terminal 50) to enable an operator to select a storage device, extract a backup storage having a second owner matching a first owner of the selected storage device, and enable the operator to select the backup storage based on the extraction result. Specifically, the control device 30 controls to prevent the operator from selecting a backup storage that is not extracted.

For example, as a control for preventing the operator from selecting a backup storage that is not extracted, the control device 30 transmits list information of only extracted backup storages to the maintenance management terminal 40, thereby presenting only the extracted backup storages as options to the operator on the maintenance management terminal 40. The control for preventing the operator from selecting a backup storage that is not extracted is not limited thereto. The same as the above-described control for preventing the operator from selecting the storage device that is not extracted, the control device 30 may control such that the backup storage that is not extracted is displayed in a form different from the form of an extracted backup storage, the backup storage that is not extracted cannot be selected, the backup storage that is not extracted cannot be selected even when an operator performs a selection operation, and warning information indicating the selection of the backup storage that is not extracted is displayed.

The control device 30 may also store administrator information (the NAS management information 31 and the storage management information 32) indicating a first administrator of a storage device and a second administrator of a backup storage. The control device 30 controls to enable an operator to select a storage device in which at least one of the backup processing and/or the restoration processing is executed from storage devices of the first administrator, and controls to enable the operator to select a backup storage to be backed up and/or restored from backup storages of the second administrator. As a result, it is possible to prevent the operator from selecting a storage device or a backup storage for which the operator does not have an instruction right of backup and/or restoration as a backup and/or restoration target.

The control device 30 may store executability information (the NAS management information 31 and the storage management information 32) that is set by a first owner (for example, the corporate companies A and B) of a storage device and that indicates whether a backup processing and/or a restoration processing is executable in the storage device. Then, the control device 30 controls to prevent an operator from selecting a storage device in which the backup processing or the restoration processing is set to be inexecutable based on the executability information.

For example, as a control for preventing the operator from selecting a storage device in which the backup processing and/or the restoration processing is set to be inexecutable, the control device 30 transmits list information of only storage devices in which a backup processing and/or a restoration processing is set to be executable to the maintenance management terminal 40, thereby presenting only the storage devices in which a backup processing and/or a restoration processing is set to be executable as options to the operator on the maintenance management terminal 40. The control for preventing the operator from selecting a storage device in which a backup processing and/or a restoration processing is set to be inexecutable is not limited thereto. The control device 30 may control such that a storage device in which a backup processing and/or a restoration processing is set to be inexecutable is presented in a form different from a form of a storage device in which a backup processing and/or a restoration processing is set to be executable, a storage device in which a backup processing and/or a restoration processing is set to be inexecutable cannot be selected, a storage device in which a backup processing and/or a restoration processing is set to be inexecutable cannot be selected even when an operator performs a selection operation, and warning information indicating the selection of a storage device in which a backup processing and/or a restoration processing is set to be inexecutable is displayed.

(Program)

Programs stored in a read-only-memory (ROM) of the memory 302 of the control device 30 are stored in a computer-readable non-transitory storage medium. Such a “computer-readable storage medium” is, for example, an optical medium such as a compact disc-ROM (CD-ROM), a magnetic storage medium such as a USB memory or a memory card, or the like. Such a program can be provided by downloading via a network.

(Control Method)

The above-described control method executed by the control device 30 may be executed by the information processing device 300 shown in FIG. 2, or may be executed by a virtual information processing device implemented in a cloud computing service.

As described above, the following matters are disclosed in the present specification.

A method disclosed in the present specification is a control method for controlling at least one of a backup processing and a restoration processing of data between one or more storage devices and one or more backup storages via a network. The method includes storing owner information indicating one or more owners of the one or more storage devices and one or more owners of the one or more backup storages, and enabling at least one of the backup processing and the restoration processing between the backup storage and the storage device when the owner of the storage device and the owner of the backup storage match each other.

The disclosed method includes enabling an operator to select at least one backup storage from the one or more backup storages, extracting a storage device owned by an owner of the selected backup storage, and enabling the operator to select a storage device based on the extraction result.

The disclosed method includes preventing the operator from selecting a storage device that has not been extracted.

The disclosed method includes outputting only the extracted storage device as an option to the operator.

The disclosed method includes enabling an operator to select at least one storage device from the one or more storage devices, extracting a backup storage owned by an owner of the selected storage device, and enabling the operator to select a backup storage based on the extraction result.

The disclosed method includes preventing the operator from selecting a backup storage that has not been extracted.

The disclosed method includes outputting only the extracted backup storage as an option to the operator.

The disclosed method further includes storing administrator information indicating one or more administrators of the one or more storage devices and one or more administrators of the one or more backup storages, enabling an operator to select a storage device for which at least one of a backup processing and a restoration processing is executed from the one or more storage devices whose administrator is the operator, and enabling the operator to select a backup storage for which at least one of a backup processing and a restoration processing is executed from the one or more backup storages whose administrator is the operator.

The disclosed method further includes storing executability information that is set by the one or more owners of the one or more storage devices and indicates whether at least one of the backup processing and the restoration processing is executable for the one or more storage devices, and preventing the operator from selecting a storage device for which at least one of the backup processing and the restoration processing is set to be inexecutable based on the executability information.

According to the disclosed method, the operator is a person different from an owner of a storage device.

A backup system disclosed in the present specification includes one or more storage devices, one or more backup storages, and a control device configured to control at least one of a backup processing and a restoration processing of data between the storage device and the backup storage via a network, store owner information indicating one or more owners of the one or more storage devices and one or more owners of the one or more backup storages, and enable at least one of the backup processing and the restoration processing between the backup storage and the storage device when the owner of the storage device and the owner of the backup storage match each other.

A non-transitory computer-readable storage medium stores a control program.

The control program is a control program of a control device that is configured to control at least one of a backup processing and a restoration processing of data between one or more storage devices and one or more backup storages via a network, causes the control device to store owner information indicating one or more owners of the one or more storage devices and one or more owners of the one or more backup storages, and causes the control device to execute a processing so as to enable at least one of the backup processing and the restoration processing between the backup storage and the storage device when the owner of the storage device and the owner of the backup storage match each other.

A control device disclosed in the present specification is a control device configured to control at least one of a backup processing and a restoration processing of data between one or more storage devices and one or more backup storages via a network. The control device includes circuitry configured to store owner information indicating one or more owners of the one or more storage devices and one or more owners of the one or more backup storages, and enable at least one of the backup processing and the restoration processing between the backup storage and the storage device when the owner of the storage device and the owner of the backup storage match each other.

1. A method comprising:
storing owner information indicating one or more owners of one or more storage devices and one or more owners of one or more backup storages; and
enabling at least one of a backup processing and a restoration processing between a first backup storage of the one or more backup storages and a first storage device of the one or more storage devices, under a condition an owner of the first storage device and an owner of the first backup storage match.

2. The method according to claim 1, further comprising:
enabling an operator to select the first backup storage from the one or more backup storages; and
extracting at least one storage device owned by the owner of the selected backup storage, and enabling the operator to select the first storage device based on an extraction result.

3. The method according to claim 2, further comprising:
preventing the operator from selecting a storage device of the one or more storage devices that has not been extracted.

4. The method according to claim 2, further comprising:
outputting only the at least one extracted storage device as an option to the operator.

5. The method according to claim 1, further comprising:
enabling an operator to select the first storage device from the one or more storage devices; and
extracting at least one backup storage owned by an owner of the first selected storage device, and enabling the operator to select the first backup storage based on an extraction result.

6. The method according to claim 5, further comprising:
preventing the operator from selecting a backup storage of the one or more backup storages that has not been extracted.

7. The method according to claim 5, further comprising:
outputting only the at least one extracted backup storage as an option to the operator.

8. The method according to claim 1, further comprising:
storing administrator information indicating one or more administrators of the one or more storage devices and one or more administrators of the one or more backup storages;
enabling the operator to select the first storage device for which at least one of the backup processing and the restoration processing is executed from the one or more storage devices, wherein the operator is an administrator of the first storage device; and
enabling the operator to select the first backup storage for which at least one of the backup processing and the restoration processing is executed from the one or more backup storages, wherein the operator is an administrator of the first backup storage.

9. The method according to claim 2,
wherein a storage device that has not been extracted is set to not be selectable.

10. The method according to claim 4, further comprising,
outputting a storage device that has not been extracted as another option to the operator in a first form different from a second form of the at least one extracted storage device.

11. The method according to claim 10, further comprising:
outputting warning information under a condition the storage device that has not been extracted is selected.

12. The method according to claim 10, further comprising:
receiving a canceling operation for cancelling a selection operation under a condition the storage device that has not been extracted is selected.

13. The method according to claim 1, further comprising:
storing executability information that is set by the one or more owners of the one or more storage devices and indicates whether at least one of the backup processing and the restoration processing is executable for the one or more storage devices; and
preventing an operator from selecting a storage device for which at least one of the backup processing and the restoration processing is set to be inexecutable, based on the executability information.

14. The method according to claim 2,
wherein the operator is a person different from the one or more owners of the first storage device.

15. A backup system comprising:
one or more storage devices;
one or more backup storages; and
a control device configured to
control at least one of a backup processing and a restoration processing of data between the one or more storage devices and the one or more backup storages via a network,
store owner information indicating one or more owners of the one or more storage devices and one or more owners of the one or more backup storages, and
enable at least one of the backup processing and the restoration processing between a first backup storage of the one or more backup storages and a first storage device of the one or more storage devices under a condition the owner of the first storage device and the owner of the first backup storage match each other.

16. A non-transitory computer readable storage medium storing a control program for causing a computer to execute the method according to claim 1.

17. A control device comprising circuitry configured to:
store owner information indicating one or more owners of one or more storage devices and one or more owners of one or more backup storages; and
enable at least one of a backup processing and a restoration processing of data between a first backup storage of the one or more backup storage and a first storage device of the one or more storage devices under a condition the owner of the first storage device and the owner of the first backup storage match each other.

18. The control device of claim 17, wherein the circuitry is further configured to:
compare the owner of the first storage device to the owner of the first backup storage device to determine a match.

19. The control device of claim 17, wherein the circuitry is further configured to:
enable an operator to select the first storage device from the one or more storage devices; and
extract at least one backup storage owned by the owner of the first selected storage device, and enable the operator to select the first backup storage based on an extraction result.

20. The control device of claim 17, wherein the circuitry is further configured to:
prevent an operator from selecting a backup storage of the one or more backup storages that has not been extracted.
